(19) United States
(12) Patent Application Publication
(10) Pub. No.: US 2026/0237119 A1
(43) Pub. Date: Aug. 13, 2026

(54) COVER PREVIEW METHOD, APPARATUS AND DEVICE, AND STORAGE MEDIUM

(71) Applicant: Beijing Zitiao Network Technology Co., Ltd., Beijing (CN)

(72) Inventors: Wanli CHE, Beijing (CN); Hao LIN, Beijing (CN)

(21) Appl. No.: 19/156,569

(22) PCT Filed: Jul. 25, 2024
(86) PCT No.: PCT/CN2024/107558

§ 371 Date: Aug. 14, 2025

(30) Foreign Application Priority Data
Aug. 7, 2023 (CN) 202310988902.X

(51) Int. Cl. G06T 11/60; G06F 3/0482; G06F 3/0483; G06F 3/04845

(52) U.S. Cl. CPC G06T 11/60; G06F 3/0482; G06F 3/0483; G06F 3/04845

(57) ABSTRACT

The present disclosure provides a cover preview method, apparatus, and device, and a storage medium. The method includes: first, presenting an editing result cover of a target multimedia work in an editing effect presentation window on a cover editing page, where a cover preview control is provided on the cover editing page; and then, presenting, on a cover preview page, a display effect image of the editing result cover on a target page in response to a trigger operation on the cover preview control, where the target page is configured to present a cover of the target multimedia work.

### CROSS-REFERENCE TO RELATED APPLICATION(S)

The present application claims priority to Chinese Patent Application No. 202310988902.X, filed on Aug. 7, 2023 and entitled “COVER PREVIEW METHOD, APPARATUS AND DEVICE, AND STORAGE MEDIUM”, which is incorporated herein by reference in its entirety.

### FIELD

The present disclosure relates to the field of data processing, and in particular to a cover preview method, apparatus, and device, and a storage medium.

### BACKGROUND

With the development of internet technology, an increasing number of users post multimedia works such as videos, images, audio on the internet. In order to enhance the dissemination of the multimedia works, posters can enrich them by setting covers and other forms.

At present, a cover editing function for multimedia works is relatively limited, how to enrich the cover editing function for multimedia works is an urgent technical problem to be solved currently.

### SUMMARY

In order to solve the above technical problems, embodiments of the present disclosure provide a cover preview method.

According to a first aspect, the present disclosure provides a cover preview method. The method includes:
presenting an editing result cover of a target multimedia work in an editing effect presentation window on a cover editing page, where a cover preview control is provided on the cover editing page; and
presenting, on a cover preview page, a display effect image of the editing result cover on a target page in response to a trigger operation on the cover preview control, where the target page is configured to present a cover of the target multimedia work.

In an optional implementation, the target page includes at least one of a user profile page, a preset column count page, and a preset row count page.

In an optional implementation, the target page includes the user profile page, and the presenting, on a cover preview page, a display effect image of the editing result cover on a target page in response to a trigger operation on the cover preview control includes:
in response to the trigger operation on the cover preview control, obtaining a target cover presented on a user profile page of a first user, where the target cover includes a cover of a homepage multimedia work on the user profile page; and
presenting a cover list image including the target cover and the editing result cover on the cover preview page, where the cover list image is used to present a display effect of the editing result cover on the user profile page of the first user.

In an optional implementation, before the presenting a cover list image including the target cover and the editing result cover on the cover preview page, the method further includes:
in response to determining that the editing result cover belongs to an image of a preset size type, performing preset image processing on the editing result cover to obtain a processed cover; and
correspondingly, the presenting a cover list image including the target cover and the editing result cover on the cover preview page includes:
presenting the cover list image including the target cover and the editing result cover on the cover preview page.

In an optional implementation, the target page includes the preset column count page, and the presenting, on a cover preview page, a display effect image of the editing result cover on a target page in response to a trigger operation on the cover preview control includes:
in response to the trigger operation on the cover preview control, obtaining a preview effect template corresponding to the preset column count page, where at least one placeholder image is displayed on the preview effect template; and
displaying the editing result cover in a target placeholder image on the preview effect template, and presenting the preview effect template including the editing result cover on the cover preview page.

In an optional implementation, the method further includes:
obtaining subject description information for the target multimedia work; and displaying the subject description information at a display position of the editing result cover on the cover preview page.

In an optional implementation, before the presenting an editing result cover of a target multimedia work in an editing effect presentation window on a cover editing page, the method further includes:
in response to a cover addition operation or a cover editing operation performed on a multimedia work posting page, displaying the cover editing page.

According to a second aspect, the present disclosure provides a cover preview apparatus. The apparatus includes:
a first presentation module configured to present an editing result cover of a target multimedia work in an editing effect presentation window on a cover editing page, where a cover preview control is provided on the cover editing page; and
a second presentation module configured to present, on a cover preview page, a display effect image of the editing result cover on a target page in response to a trigger operation on the cover preview control, where the target page is configured to present a cover of the target multimedia work.

According to a third aspect, the present disclosure provides a computer-readable storage medium, where the computer-readable storage medium stores instructions therein, and the instructions, when executed on a terminal device, cause the terminal device to implement the method described above.

According to a fourth aspect, the present disclosure provides a cover preview device, including: a memory, a processor, and a computer program that is stored on the memory and executable on the processor, where the processor, when executing the computer program, implements the method described above.

According to a fifth aspect, the present disclosure provides a computer program product. The computer program product includes a computer program/instruction. The computer program/instruction, when executed by a processor, causes the method described above to be implemented.

The embodiments of the present disclosure provide the cover preview method. First, the editing result cover of the target multimedia work is presented in the editing effect presentation window on the cover editing page, where the cover preview control is provided on the cover editing page. Then, the display effect image of the editing result cover on the target page is presented on the cover preview page in response to the trigger operation on the cover preview control, where the target page is configured to present the cover of the target multimedia work.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a flowchart of a cover preview method according to an embodiment of the present disclosure;

FIG. 2 is a schematic diagram of a multimedia work posting page according to an embodiment of the present disclosure;

FIG. 3 is a schematic diagram of another multimedia work posting page according to an embodiment of the present disclosure;

FIG. 4 is a schematic diagram of a cover editing page of a multimedia work according to an embodiment of the present disclosure;

FIG. 5 is a schematic diagram of a cover preview page according to an embodiment of the present disclosure;

FIG. 6 is a schematic diagram of another cover preview page according to an embodiment of the present disclosure;

FIG. 7 is a schematic structural diagram of a cover preview apparatus according to an embodiment of the present disclosure; and

FIG. 8 is a schematic structural diagram of a cover preview device according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

At present, with the development of internet technology, an increasing number of users post multimedia works on the internet. In order to enhance the dissemination of the multimedia works, posters can enrich them by setting covers and other forms.

However, at present, a cover editing function for multimedia works is relatively limited, how to enrich the cover editing function for multimedia works is an urgent technical problem to be solved currently.

Therefore, embodiments of the present disclosure provide a cover preview method. First, an editing result cover of a target multimedia work is presented in an editing effect presentation window on a cover editing page, where a cover preview control is provided on the cover editing page. Then, a display effect image of the editing result cover on a target page is presented on a cover preview page in response to a trigger operation on the cover preview control, where the target page is configured to present a cover of the target multimedia work. It can be learned that in this embodiment of the present disclosure, the display effect image of the cover of the multimedia work on the target page can be presented on the cover preview page by providing the cover preview control on the cover editing page, so that a user previews a display effect of the cover of the multimedia work presented on the target page, and a cover editing-related function for the multimedia work is enriched.

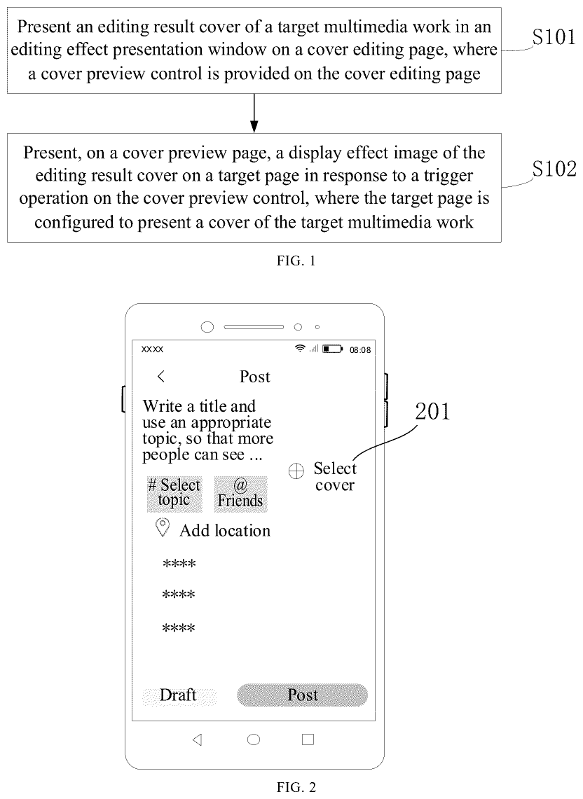

Based on this, an embodiment of the present disclosure provides a cover preview method. As shown in FIG. 1, which is a flowchart of a cover preview method according to an embodiment of the present disclosure, the method specifically includes the following steps.

S101: An editing result cover of a target multimedia work is presented in an editing effect presentation window on a cover editing page.

A cover preview control is provided on the cover editing page, and is configured to preview an edited cover, that is, the editing result cover.

The cover preview method provided in this embodiment of the present disclosure is applicable to a client. For example, the client may include a client deployed on a smartphone, a client deployed on a tablet computer, etc.

In an optional implementation, in response to a cover addition operation or a cover editing operation performed on a multimedia work posting page, the cover editing page is displayed. The cover editing page is configured to perform a related editing operation on a cover of a multimedia work, for example, addition of a filter template, text, etc.

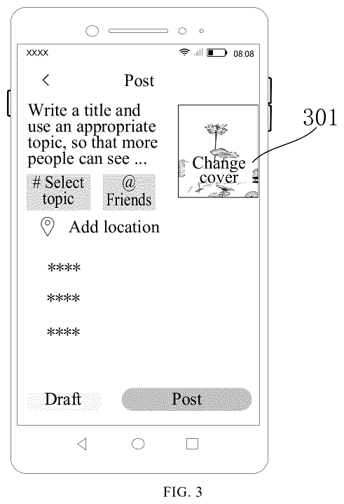

FIG. 2 is a schematic diagram of a multimedia work posting page according to an embodiment of the present disclosure. After a user triggers a posting operation on a target multimedia work, a multimedia work posting page is displayed, and a cover addition control 201 is displayed on the multimedia work posting page. When a trigger operation on the cover addition control 201 on the multimedia work posting page is received, a cover addition page is displayed. After cover addition is implemented based on the cover addition page, the cover addition page navigated to a cover editing page.

In practical application, after the user completes addition and editing of a cover, in order for the user to edit the cover of the multimedia work again, a cover editing control may be provided on the multimedia work posting page. FIG. 3 is a schematic diagram of another multimedia work posting page according to an embodiment of the present disclosure. When a user triggers a cover editing control 301 on a target multimedia work posting page, a cover editing page is displayed for the user to edit the cover again.

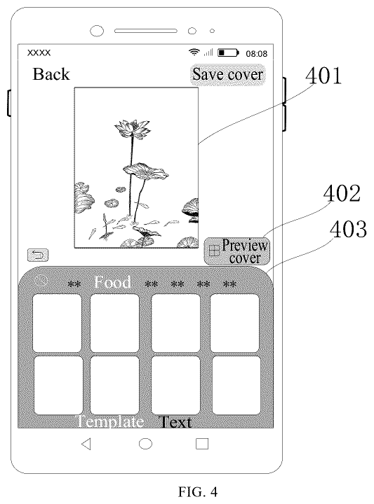

FIG. 4 is a schematic diagram of a cover editing page of a multimedia work according to an embodiment of the present disclosure. An editing result cover 401 of a target multimedia work is presented in an editing effect presentation window on a cover editing page. The cover editing page displays a cover preview control 402, and further displays a cover editing function panel 403. The cover editing function panel 403 is configured to allow the user to trigger various editing operations on a cover to obtain an editing result cover, and present the editing result cover in the editing effect presentation window. The editing operation on the cover is, for example, triggering a food filter template to perform a food filter operation on the cover.

In practical application, to meet a requirement of the user to change the cover, a cover change control may be further provided on the cover editing page, so that the user triggers the change of the cover.

S102: A display effect image of the editing result cover on a target page is presented on a cover preview page in response to a trigger operation on the cover preview control.

The target page is configured to present a cover of the target multimedia work.

In embodiments of the present disclosure, a display effect of the editing result cover on the target page may be previewed by triggering the cover preview control.

In embodiments of the present disclosure, the target page includes at least one of a user profile page, a preset column count page, and a preset row count page.

For example, the user profile page may be a profile page of a poster of the target multimedia work. The preset column count page may include a two-column page, a three-column page, or another page arranged in similar manner. For example, the preset column count page may be a multimedia content recommendation page or a content search page or the like. The preset row count page may include a two-row page, a three-row page, or another page arranged in a similar manner.

In an optional implementation, the target page may include various types of pages for presenting the cover of the target multimedia work after the target multimedia work has been successfully posted, such as the user profile page, and the multimedia content recommendation page.

In the cover preview method provided in this embodiment of the present disclosure, first, the editing result cover of the target multimedia work is presented in the editing effect presentation window on the cover editing page, where the cover preview control is provided on the cover editing page. Then, the display effect image of the editing result cover on the target page is presented on the cover preview page in response to the trigger operation on the cover preview control, where the target page is configured to present the cover of the target multimedia work. It can be learned that in this embodiment of the present disclosure, the display effect image of the cover of the multimedia work on the target page can be presented on the cover preview page by providing the cover preview control on the cover editing page, so that the user previews a display effect of the cover of the multimedia work presented on the target page, and a cover editing-related function for the multimedia work is enriched.

For ease of understanding, this embodiment of the present disclosure is described by using an example of a specific scenario in which the target page is the user profile page. Details are as follows:

In an optional implementation, in response to the trigger operation on the cover preview control, a target cover presented on a profile page of a first user is obtained, where the target cover includes a cover of a homepage multimedia work on the profile page of the first user. Then, a cover list image including the target cover and the editing result cover is presented on the cover preview page. The cover list image is used to present a display effect of the editing result cover on the profile page of the first user. The first user is a currently logged-in user.

In order to realistically restore a display status of the editing result cover on the cover list image on the user profile page, in this embodiment of the present disclosure, the cover of the multimedia work presented on the profile page of the first user needs to be obtained when the cover list image including the target cover and the editing result cover is presented on the cover preview page, to increase realism of presenting the cover list image including the target cover and the editing result cover on the cover preview page.

In order to further increase the realism of presenting the cover list image including the target cover and the editing result cover on the cover preview page, in this embodiment of the present disclosure, presentation may alternatively be performed based on presentation order setting information for the multimedia work.

Specifically, presentation order setting information for the multimedia work of the user profile page of the first user is obtained. Presentation positions of the target cover and the editing result cover on the cover list image are determined based on the presentation order setting information, and the cover list image is presented on the cover preview page based on the presentation positions of the target cover and the editing result cover on the cover list image.

It should be noted that if there is a pinned multimedia work on the user profile page of the first user, the pinned multimedia work is presented preferentially in the cover list image on the cover preview page, and a cover corresponding to an unpinned multimedia work and the editing result cover are presented in the cover list image based on the presentation order setting information. A presentation position of the pinned multimedia work in the cover list image on the cover preview page may be, for example, the first position.

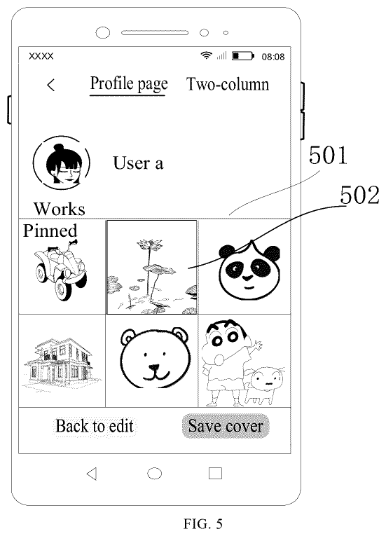

For example, FIG. 5 is a schematic diagram of a cover preview page according to an embodiment of the present disclosure. The cover preview page is presented as a profile page of a currently logged-in user, where the cover list image including the target cover and the editing result cover is presented on the cover preview page, and the target cover and the editing result cover are presented on the cover list image based on the presentation setting information for the multimedia work. As shown in the figure, 501 is the cover list image, and 502 is the editing result cover. The presentation positions of the target cover and the editing result cover on the cover list image are shown on the cover preview page of FIG. 5.

In practical application, to further increase realism of the editing result cover in the user profile page scenario, in embodiments of the present disclosure, user account information, which may specifically include avatar, username, etc., of the first user may be further presented on the cover preview page, to realistically restore a display status of the editing result image on the user profile page. As shown on the cover preview page of FIG. 5, the avatar, the username, etc. of the first user are presented on the cover preview page.

In addition, in order to help the user quickly preview, on the cover preview page, the display effect of the editing result cover on the target cover, and further improve user experience, prominent display may be set for the editing result cover displayed in the cover list image on the cover preview page, for example, highlighted display or other operations.

In this embodiment of the present disclosure, based on the user profile page scenario of the first user, the display effect image of the editing result cover in the user profile page scenario of the first user is presented on the cover preview page, and prominent display is set for the editing result cover. The cover list image including the target cover and the editing result cover is presented on the cover preview page based on the presentation order setting information, to improve user experience.

In practical application, because the cover list image on the user profile page is used to display the cover of the multimedia work of the current user, where a size for displaying the cover is fixed, there may be a case in which a cover size of the multimedia work displayed in the cover list image does not match a size of the editing result cover when the cover list image including the target cover and the editing result cover is presented on the cover preview page. In order to realistically restore the display status, on the user profile page, of the editing result cover presented on the cover preview page, preset image processing is performed on the editing result cover in this embodiment of the present disclosure.

Specifically, in response to determining that the editing result cover belongs to an image of a preset size type, preset image processing is performed on the editing result cover to obtain a processed editing result cover. Correspondingly, the cover list image including the target cover and the editing result cover is presented on the cover preview page, where the image of the preset size type is an image that does not conform to a cover display area of the multimedia work in the cover list image on the user profile page, preset image processing may be to crop the editing result cover based on a user requirement. For example, assuming that the cover display area in the cover list image is a vertical cover image and the image of the preset size type is a horizontal cover image, the editing result cover needs to be cropped, to further increase realism of the editing result cover for presenting the cover list image including the target cover and the editing result cover on the cover preview page.

In this embodiment of the present disclosure, preset image processing is performed on the editing result cover belonging to the image of the preset size type, so that the realism of the editing result cover on the cover preview page is increased to some extent, and a cover editing-related function for the multimedia work is further enriched.

Based on the above embodiment, alternatively, this embodiment of the present disclosure is described by using an example of a specific scenario in which the target page is the two-column page. Details are as follows:

In another optional implementation, in response to the trigger operation on the cover preview control, a preview effect template corresponding to the preset column count page is obtained, where at least one placeholder image is displayed on the preview effect template. The editing result cover is displayed in a target placeholder image on the preview effect template, and the preview effect template including the editing result cover is presented on the cover preview page.

In order to present an actual display status of the editing result cover in the two-column page scenario on the cover preview page so that the user previews display effects of the editing result cover in different scenarios, so that a plurality of placeholder images are included on the preview effect template, to indicate the cover of the multimedia work.

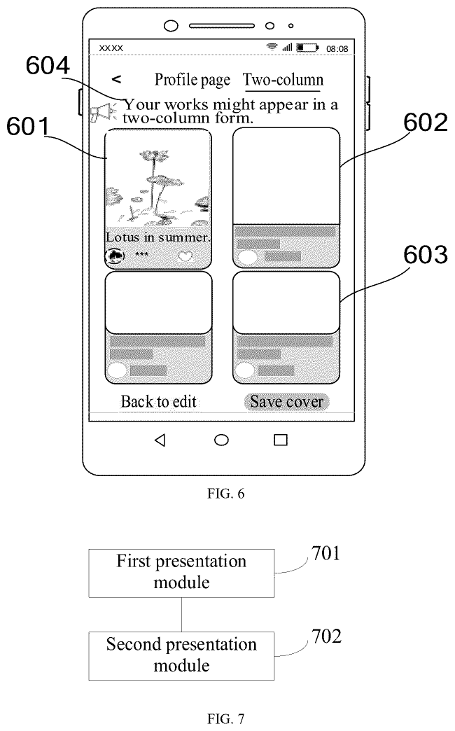

FIG. 6 is a schematic diagram of another cover preview page according to an embodiment of the present disclosure. A two-column preview effect template including the editing result cover is presented on the cover preview page, where the two-column preview effect template includes a plurality of placeholder images shown as 601, 602, and 603, to display the cover of the multimedia work, and the editing result cover is displayed as 601.

It should be noted that because the preview effect template is a display template for the cover of the multimedia work in different scenarios, such as a two-column display template or a three-column display template in a multimedia work recommendation page scenario, a channel search page scenario, and other scenarios, display positions of the cover of the multimedia work viewed by a viewing user are different, so that a display position of the cover of the multimedia work in the preview effect template is not controllable.

In order to present an actual display status of the editing result cover in the two-column page or three-column page scenario on the cover preview page so that the user previews display effects of the editing result cover in different scenarios, the preview effect template includes a plurality of placeholder images, where the placeholder image included in the preview effect template is used to display the cover of the multimedia work.

Therefore, when the two-column preview effect template including the editing result cover is presented on the cover preview page, a display position of the editing result cover in the preview effect template may be the first position or another position. This is not limited in this embodiment of the present disclosure.

To allow the user to preview display effects of the editing result cover at different positions, the user may drag and drop the editing result cover into any placeholder image in the preset effect template, so that the user previews the display effects of the editing result cover at the different positions.

In addition, in order to realistically restore display statuses of the editing result cover in different scenarios, subject description information of the multimedia work may be further displayed on the placeholder image in the preset effect template in embodiments of the present disclosure. The subject description information is description content added to the multimedia work before the multimedia work is posted, such as text, stickers, and icons.

Specifically, the subject description information of the target multimedia work is obtained, and then, the subject description information is displayed at a display position of the editing result cover on the cover preview page. For example, at a position 601 in the cover preview page of FIG. 6, the subject description information of the multimedia work is shown in the cover preview page of FIG. 6. The display position of the subject description information of the multimedia work is not limited in this embodiment of the present disclosure.

In practical application, if the user does not add the subject description information to the multimedia work, preset subject description information may be displayed at the display position of the editing result cover on the cover preview page, to prompt the user to add the subject description information to the multimedia work, and the preset subject description information is, for example, “Add a work description . . . ”.

In order to further restore actual display statuses of the editing result cover in different scenarios, user account information such as an avatar, a user name and a quantity of likes, may be further displayed on the placeholder image in the preview effect template, as shown in 601 on the cover preview page of FIG. 6. The user personal account information is displayed in the preview effect template, to further increase realism of the editing result cover in different scenarios.

In addition, size fitting is performed on the preset effect template based on a size of the editing result cover, to further increase the realism of the editing result cover in the different scenarios. For example, assuming that the editing result cover is a horizontal cover, a size of the placeholder image in the preview effect template may be fitted based on an aspect ratio of the horizontal cover, to display the editing result cover.

In addition, in order to inform the user of a possible scenario for the cover of the multimedia work of the user so that the user has a more definite expectation on presentation of the editing result cover, prompt information may be further presented on the cover preview page, as shown in 604 on the cover preview page of FIG. 6.

The prompt information is displayed on the cover preview page, so that the user can know in advance display effects of the cover of the multimedia work in different scenarios, and the user can change the cover in time and edit the cover, thereby improving user experience.

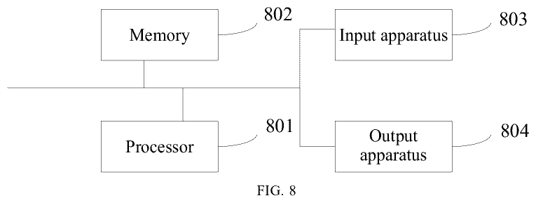

Based on the above method embodiment, the present disclosure further provides a cover preview apparatus. As shown in FIG. 7, which is a schematic structural diagram of a cover preview apparatus according to an embodiment of the present disclosure, the apparatus includes:
a first presentation module 701 configured to present an editing result cover of a target multimedia work in an editing effect presentation window on a cover editing page, where a cover preview control is provided on the cover editing page; and
a second presentation module 702 configured to present, on a cover preview page, a display effect image of the editing result cover on a target page in response to a trigger operation on the cover preview control, where the target page is configured to present a cover of the target multimedia work.

In an optional implementation, the target page includes at least one of a user profile page, a preset column count page, and a preset row count page.

In an optional implementation, the target page includes the user profile page, and the second presentation module includes:
a first obtaining sub-module configured to: in response to the trigger operation on the cover preview control, obtain a target cover presented on a user profile page of a first user, where the target cover includes a cover of a homepage multimedia work on the user profile page; and
a first presentation sub-module configured to present a cover list image including the target cover and the editing result cover on the cover preview page, where the cover list image is used to present a display effect of the editing result cover on the user profile page of the first user.

In an optional implementation, the apparatus further includes:
an image processing module configured to: when determining that the editing result cover belongs to an image of a preset size type, perform preset image processing on the editing result cover to obtain a processed cover; and
correspondingly, the first presentation sub-module is specifically configured to:
present the cover list image including the target cover and the editing result cover on the cover preview page.

In an optional implementation, the target page includes the preset column count page, and the second presentation module includes:
a second obtaining sub-module configured to: in response to the trigger operation on the cover preview control, obtain a preview effect template corresponding to the preset column count page, where at least one placeholder image is displayed on the preview effect template; and
a second presentation sub-module configured to display the editing result cover in a target placeholder image on the preview effect template, and present the preview effect template including the editing result cover on the cover preview page.

In an optional implementation, the apparatus further includes:
a first obtaining module configured to obtain subject description information for the target multimedia work; and
a first display module configured to display the subject description information at a display position of the editing result cover on the cover preview page.

In an optional implementation, the apparatus further includes:
a second display module configured to: in response to a cover addition operation or a cover editing operation performed on a multimedia work posting page, display the cover editing page.

In the cover preview method provided in this embodiment of the present disclosure, first, the editing result cover of the target multimedia work is presented in the editing effect presentation window on the cover editing page, where the cover preview control is provided on the cover editing page. Then, the display effect image of the editing result cover on the target page is presented on the cover preview page in response to the trigger operation on the cover preview control, where the target page is configured to present the cover of the target multimedia work. It can be learned that in this embodiment of the present disclosure, the display effect image of the cover of the multimedia work on the target page can be presented on the cover preview page by providing the cover preview control on the cover editing page, so that a user previews a display effect of the cover of the multimedia work presented on the target page, and a cover editing-related function for the multimedia work is enriched.

In addition to the method and apparatus described above, an embodiment of the present disclosure further provides a computer-readable storage medium having instructions stored therein. The instructions, when executed on a terminal device, cause the terminal device to implement the cover preview method described in the embodiments of the present disclosure.

An embodiment of the present disclosure further provides a computer program product. The computer program product includes a computer program or instructions. The computer program or instructions, when executed by a processor, cause the cover preview method described in the embodiments of the present disclosure to be implemented.

In addition, an embodiment of the present disclosure further provides a cover preview device. As shown in FIG. 8, the device may include:
a processor 801, a memory 802, an input apparatus 803, and an output apparatus 804. There may be one or more processors 801 in the cover preview device. For example, there is one processor in FIG. 8. In some embodiments of the present disclosure, the processor 801, the memory 802, the input apparatus 803, and the output apparatus 804 may be connected through a bus or in another manner, for example, are connected through the bus in FIG. 8.

The memory 802 may be configured to store a software program and a module. The processor 801 performs various functional applications of the cover preview device and processes data by executing the software program and the module stored in the memory 802. The memory 802 may mainly include a program storage area and a data storage area. The program storage area may store an operating system, an application required by at least one function, and the like. In addition, the memory 802 may include a high-speed random-access memory, and may further include a non-volatile memory, such as at least one magnetic disk storage device, a flash memory device, or other volatile solid-state storage devices. The input apparatus 803 may be configured to receive entered numerical or character information, and generate a signal input related to a user setting and function control of the cover preview device.

Specifically, in this embodiment, the processor 801 loads an executable file corresponding to a process of one or more applications into the memory 802 in accordance with the following instructions, and the processor 801 runs the application stored in the memory 802, to implement various functions of the above cover preview device.

It should be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. A cover preview method, comprising:
presenting an editing result cover of a target multimedia work in an editing effect presentation window on a cover editing page, wherein a cover preview control is provided on the cover editing page; and
presenting, on a cover preview page, a display effect image of the editing result cover on a target page in response to a trigger operation on the cover preview control, wherein the target page is configured to present a cover of the target multimedia work.

2. The method according to claim 1, wherein the target page comprises at least one of a user profile page, a preset column count page, and a preset row count page.

3. The method according to claim 2, wherein the target page comprises the user profile page, and the presenting, on a cover preview page, a display effect image of the editing result cover on a target page in response to a trigger operation on the cover preview control comprises:
in response to the trigger operation on the cover preview control, obtaining a target cover presented on a user profile page of a first user, wherein the target cover comprises a cover of a homepage multimedia work on the user profile page; and
presenting a cover list image comprising the target cover and the editing result cover on the cover preview page, wherein the cover list image is used to present a display effect of the editing result cover on the user profile page of the first user.

4. The method according to claim 3, wherein before the presenting a cover list image comprising the target cover and the editing result cover on the cover preview page, the method further comprises:
in response to determining that the editing result cover belongs to an image of a preset size type, performing preset image processing on the editing result cover to obtain a processed cover.

5. The method according to claim 2, wherein the target page comprises the preset column count page, and the presenting, on a cover preview page, a display effect image of the editing result cover on a target page in response to a trigger operation on the cover preview control comprises:
in response to the trigger operation on the cover preview control, obtaining a preview effect template corresponding to the preset column count page, wherein at least one placeholder image is displayed on the preview effect template; and
displaying the editing result cover in a target placeholder image on the preview effect template, and presenting the preview effect template comprising the editing result cover on the cover preview page.

6. The method according to claim 5, further comprising:
obtaining subject description information for the target multimedia work; and
displaying the subject description information at a display position of the editing result cover on the cover preview page.

7. The method according to claim 1, wherein before the presenting an editing result cover of a target multimedia work in an editing effect presentation window on a cover editing page, the method further comprises:
in response to a cover addition operation or a cover editing operation performed on a multimedia work posting page, displaying the cover editing page.

8. (canceled)

9. A non-transitory computer-readable storage medium storing instructions that, when executed on a terminal device, cause the terminal device to:
present an editing result cover of a target multimedia work in an editing effect presentation window on a cover editing page, wherein a cover preview control is provided on the cover editing page; and
present, on a cover preview page, a display effect image of the editing result cover on a target page in response to a trigger operation on the cover preview control, wherein the target page is configured to present a cover of the target multimedia work.

10. A cover preview device, comprising: a memory, a processor, and a computer program that is stored on the memory and executable on the processor, the processor, when executing the computer program, cause the device to:
present an editing result cover of a target multimedia work in an editing effect presentation window on a cover editing page, wherein a cover preview control is provided on the cover editing page; and
present, on a cover preview page, a display effect image of the editing result cover on a target page in response to a trigger operation on the cover preview control, wherein the target page is configured to present a cover of the target multimedia work.

11. (canceled)

12. The non-transitory computer-readable storage medium according to claim 9, wherein the target page comprises at least one of a user profile page, a preset column count page, and a preset row count page.

13. The non-transitory computer-readable storage medium according to claim 12, wherein the target page comprises the user profile page, wherein the instructions to present, on a cover preview page, a display effect image of the editing result cover on a target page in response to a trigger operation on the cover preview control comprise instructions to:
in response to the trigger operation on the cover preview control, obtain a target cover presented on a user profile page of a first user, wherein the target cover comprises a cover of a homepage multimedia work on the user profile page; and
present a cover list image comprising the target cover and the editing result cover on the cover preview page, wherein the cover list image is used to present a display effect of the editing result cover on the user profile page of the first user.

14. The non-transitory computer-readable storage medium according to claim 13, wherein the instructions to present a cover list image comprising the target cover and the editing result cover on the cover preview page comprise instructions to:
in response to determining that the editing result cover belongs to an image of a preset size type, perform preset image processing on the editing result cover to obtain a processed cover.

15. The non-transitory computer-readable storage medium according to claim 12, wherein the instruction to present, on a cover preview page, a display effect image of the editing result cover on a target page in response to a trigger operation on the cover preview control comprise instructions to:
in response to the trigger operation on the cover preview control, obtain a preview effect template corresponding to the preset column count page, wherein at least one placeholder image is displayed on the preview effect template; and
display the editing result cover in a target placeholder image on the preview effect template, and presenting the preview effect template comprising the editing result cover on the cover preview page.

16. The non-transitory computer-readable storage medium according to claim 15, further comprising instructions to:
obtain subject description information for the target multimedia work; and
display the subject description information at a display position of the editing result cover on the cover preview page.

17. The non-transitory computer-readable storage medium according to claim 9, wherein the instructions to an editing result cover of a target multimedia work in an editing effect presentation window on a cover editing page comprise instructions to:
in response to a cover addition operation or a cover editing operation performed on a multimedia work posting page, display the cover editing page.

18. The cover preview device according to claim 10, wherein the target page comprises at least one of a user profile page, a preset column count page, and a preset row count page.

19. The cover preview device according to claim 18, wherein the target page comprises the user profile page, wherein the processor causing the cover preview device to present, on a cover preview page, a display effect image of the editing result cover on a target page in response to a trigger operation on the cover preview control further causes the cover preview device to:
in response to the trigger operation on the cover preview control, obtain a target cover presented on a user profile page of a first user, wherein the target cover comprises a cover of a homepage multimedia work on the user profile page; and
present a cover list image comprising the target cover and the editing result cover on the cover preview page, wherein the cover list image is used to present a display effect of the editing result cover on the user profile page of the first user.

20. The cover preview device according to claim 19, wherein the processor causing the cover preview device to present a cover list image comprising the target cover and the editing result cover on the cover preview page further causes the cover preview device to:
in response to determining that the editing result cover belongs to an image of a preset size type, perform preset image processing on the editing result cover to obtain a processed cover.

21. The cover preview device according to claim 18, wherein the target page comprises the preset column count page, wherein the processor causing the cover preview device to present, on a cover preview page, a display effect image of the editing result cover on a target page in response to a trigger operation on the cover preview control further causes the cover preview device to:
in response to the trigger operation on the cover preview control, obtain a preview effect template corresponding to the preset column count page, wherein at least one placeholder image is displayed on the preview effect template; and
display the editing result cover in a target placeholder image on the preview effect template, and presenting the preview effect template comprising the editing result cover on the cover preview page.

22. The cover preview device according to claim 21, wherein the processor further causes the cover preview device to:
obtain subject description information for the target multimedia work; and
display the subject description information at a display position of the editing result cover on the cover preview page.
